(19) United States
(12) Patent Application Publication
(10) Pub. No.: US 2007/0212918 A1
(43) Pub. Date: Sep. 13, 2007

(54) Socket/plug coupling unit

(76) Inventors: Edwin Gruebel, Widnau (CH); Wolfgang J. Mueller, Lustenau (AT); Manfred Vith, Klaus (AT)

Correspondence Address: McCulloch PLC, 1st Floor, 5291 Colony Drive North, Saginaw, MI, 48638, US

(21) Appl. No.: 11/373,871

(22) Filed: Mar. 10, 2006

(51) Int. Cl. H01R 13/52

(52) U.S. Cl. 439/271

(57) ABSTRACT

According to the invention, an attachment receptacle (10) which can be fixed on a head covering, such as a helmet 5, of a user and has a clamping device is provided. The attachment receptacle 10 is fixed on the one hand by means of a fixing component, for example having hook-like retaining brackets 9a, 9b, on the back of a head covering and is connected via a clamping element, such as a tensioning strap 6, to the front or to a sighting device mounted on the front, such as a night vision device 2. The clamping element can preferably be clamped by means of the clamping device so that the attachment receptacle 10 is pressed firmly onto the head covering. The attachment receptacle 10 with the clamping device is formed in such a way that externally accessible components, such as a clamping lever 11 of the clamping device are integrated in the form of the receptacle, e.g. in the form of a housing 12 of the receptacle, in such a way that no projecting or protruding components can cause unintentional actuation of the clamping device. The attachment receptacle 10 is furthermore advantageously formed on the head covering so as to be adjustable in height.

The invention relates to a socket/plug coupling unit according to the preamble of claim 1.

Conventional socket/plug coupling units have a socket and a plug, each having electrical contacts via which the electrical connection can be produced. Such coupling units are used, for example, for producing connections—for example for a power supply, for components arranged in different parts of a device, such as controls, or for data lines—in high-quality electrical, electronic or optoelectronic devices.

For electrical connection, it is necessary for the contacts of the socket and of the plug to touch with appropriate contact pressure. This contact is achieved on coupling socket and plug.

One side each of socket and plug is provided for coupling the elements with one another—generally by inserting the plug into the socket. On the respective other side—generally the opposite side—of socket and plug, a connection is made to further conductor elements, such as a circuit board or wires, the socket or the plug being connected to a power supply via the conductor elements. The socket and/or plug are generally installed on the connection side, for example in a device as mentioned above.

Usually, the socket is chosen as the current-carrying—active—element or the current-carrying element is referred to as socket. With regard to the current-carrying element, it is necessary for its electrical contact to be sealed from the outside and thus protected from penetrating water and dirt. Particularly in the case of sockets and/or plugs which are used in devices which are employed in the open air and optionally under all weather conditions this tightness to water and dirt is essential. A user is often confronted with the problem that various applications demand the uncoupling of socket and plug, both socket and plug being exposed to the environmental influences in the uncoupled state but the contacts not being permitted to become wet or soiled.

Coupling units which are water-tight in the coupled state due to suitable seating components are known in the prior art. However, these coupling units lose their tightness when uncoupled.

For achieving tightness both in the coupled and in the uncoupled state, seating elements, such as covers or seating caps, which tightly cover the region of the electrical contacts in the uncoupled state are known for the seating of sockets and/or plugs. Such covers or seating caps are mounted, for example, by means of a cord or a band on an electrical device in which socket and/or plug are installed.

In the case of such—external—seating elements, however, manual actuation by the user is required. The tatter has to mount the seating elements property on the corresponding element or the elements—socket and/or plug—each time after undoing the coupling—uncoupling the coupling unit. Seating elements which are formed so that—for example as a result of spring mechanisms or gravitational force—they automatically close after release of the coupling must nevertheless be manually released, opened or removed during coupling.

This is disadvantageous in particular for applications such as, for example, military or surveying applications, since the user often does not have both hands free, which makes removal of the sealing element and simultaneous coupling of socket and plug difficult. Furthermore, such coupling units or seating elements are inconvenient if—for example owing to low temperatures or environmental or ambient conditions which require the wearing of protective suits—the user is wearing gloves with which in particular relatively small components cannot be easily handled.

Another disadvantage is that the requirement for good accessibility to the seating element necessitates that the coupling unit or the corresponding element of the coupling unit must be mounted in a readily accessible position—for example of a device.

Another disadvantage of such a seat is that electrical contacts are not protected from the outside in the period between removal of the seal and achievement of the coupled state. Consequently, for example, raindrops, sea spray or dust may penetrate into the contact space and lead to failure of the electrical connection owing to corrosion, soiling or leakage current.

In order to eliminate the disadvantage of the prior art, an object of the present invention is to provide a socket/plug coupling unit which is improved or simplified with regard to its seating and handling.

This object is achieved by a socket/plug coupling unit in which the characterizing features of claim 1 or of the dependent claims are realized, or the solution is further developed.

According to the invention, a coupling unit having an active element which is seated from the outside both in the coupled and in the uncoupled state is provided by the formation of the active element of the socket/plug coupling unit with a seating element, by the arrangement and mounting of the sealing element and by the formation of the passive element. In particular, the tightness is achieved so to speak automatically by means of the unit in that no—for example external or separate—device for sealing the active element has to be actuated by the user, which substantially simplifies the handling for the user.

The active element is the current-carrying element, or element intended for carrying the current, of the unit. In the description of the invention, the active element is referred to as socket element and the passive element as plug element. The socket element has a socket housing and electrical socket contact elements arranged in the socket housing. The socket contact elements are present completely within the socket housing on their side intended for contact with the plug contact elements.

For establishing the coupled state in which the respective contact elements of socket and plug elements touch so that an electrical connection is produced or can be produced the plug element is introduced through an orifice into the socket housing of the socket element. For uncoupling socket and plug element, the plug element is removed from the socket housing at least until the electrical connection is broken.

The sealing element is displaceably mounted in the socket housing in such a way that, in the uncoupled state of the socket/plug coupling unit, it is pressed indirectly or directly against the edge of the orifice of the socket housing so that said orifice is seated from the outside. In the coupled state, a component—for example the plug housing—of the plug element is pressed indirectly or directly against the edge of the orifice so that the orifice is tightly closed even in the coupled state. Consequently, the socket contact elements arranged in the socket housing are sealed on the orifice side both in the coupled and in the uncoupled state. The sealing mechanism is actuated automatically by the coupling process. As a result of the formation according to the invention, the tightness is furthermore not interrupted either during coupling or during uncoupling.

The sealing element mounted in the socket housing—if appropriate in the middle—is, for example, in the form of a sealing plug. In its shape, it is adapted to the desired function i.e. adapted on its underside—facing the plug element or the orifice—to the orifice in such a way that the appropriately tight closure is permitted. This is achieved, for example, by a formation which effects an indirect or direct all round connection between seating element and orifice, for example by a sealing element which covers the orifice and rests against the orifice edge all round.

The mounting in the socket housing is affected in such a way that the sealing element is pressed indirectly or directly against the edge of the orifice on pulling out or removing the plug element or when the plug element has been pulled out or removed. If the mounting is effected by means of a spring element or a plurality of spring elements, the sealing element is pressed or pretensioned by the force of the spring elements in a downward direction—toward the orifice—against the edge of the orifice when socket and plug elements are uncoupled. In order to apply the required spring force, mounting by means of at least two spring elements is advantageous. The spring element may be customary pressure springs, such as coil springs.

For example support surfaces for the spring element or of the spring elements are formed in the socket housing for mounting the springs. Furthermore, the sealing element, preferably has receptacles for the spring elements, for example adapted recesses, such as blind holes. Because the spring elements are arranged in receptacles, a stable position of the spring elements—and hence reliable mounting of the seating element—is ensured, and possible bending of the spring elements is avoided. Said spring elements can also be loosely mounted in the respective receptacles. Fixing means, such as hooks or eyes, can also be provided for fixing the spring elements in the receptacles, so that said spring elements do not fall out on opening the socket housing.

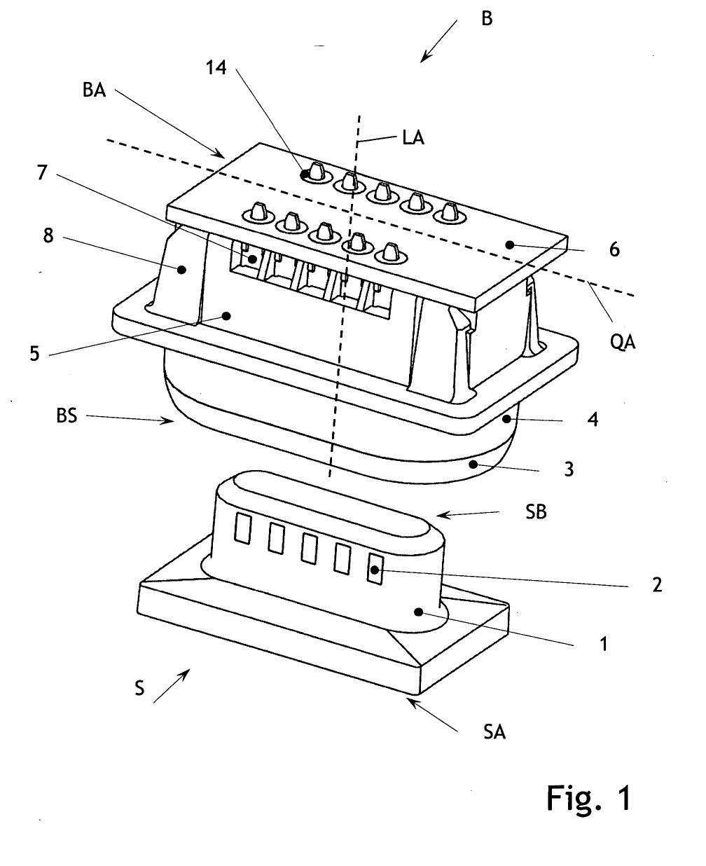

On coupling the socket element with the plug element, the plug element, as mentioned above, is inserted, such as pushed in or plugged in, through the orifice into the socket housing. In particular, the coupling process is effected by placing the plug element at the top or on the plug socket side (cf. for example FIG. 1) against the seating element and moving the seating element into the socket housing on introduction, the plug element occupying the corresponding freed space in the socket housing. The movement is in particular an axial displacement in the direction of the side opposite the orifice or socket plug side. In general, the side opposite the socket plug side is the socket connection side to which the socket element is connected via the socket contact elements to further conductor elements, for example a circuit board of a device. This socket element can, however, also be formed in such a way that the connection takes place at another point, for example laterally.

In order to facilitate placement of the plug element or of the corresponding component, such as the corresponding housing region, of the plug element against the seating element, corresponding diametrically opposite contours can be provided on the sealing element and/or on the plug element. For example, the seating element has at its bottom an all round bevel for a corresponding bevel-like contour of the plug housing. Seating element and plug housing can also have connecting elements, such as locking elements or recesses and corresponding pins or hooks. Such contours or connecting elements serve as an introduction aid and optionally centering aid.

The seating element rests indirectly or directly against the edge of the orifice in the uncoupled state and the plug element rests indirectly or directly against the edge of the orifice in the coupled state. If a seating component is arranged all round in the edge region of the orifice, the sealing element and the plug housing preferably rest against the edge of the orifice indirectly via the seating component. A suitable sealing component is, for example, a seating ring having a sealing lip. The inward-directed sealing lip cooperates with the sealing element and the plug element so that the orifice is tightly seated from water, dirt, etc. With an appropriate formation of the plug element and of the sealing component, moisture and dirt can be scraped off from the plug element or from the plug contact elements on insertion of the plug element by means of a sealing component—for example by means of a sealing lip of the sealing ring.

In this context, sealing ring is to be understood as meaning not an exclusively annular seating ring but a sealing ring which is adapted to the shape of the orifice and may be, for example, round, oval, approximately rectangular or square. The sealing ring or the sealing component is formed from customary seating materials, for example from rubber-like material, and can be firmly connected to the housing. The connection can be effected by means of a material connection—for example by adhesive bonding, molding on or vulcanization, depending on the material.

The plug element may have a further seal. It may be possible to mount on the plug housing a seal which cooperates with the sealing component of the socket element, for example sealing component and seal could be formed with parts fitting one into the other. A seal of the plug element could also be provided alternatively to a sealing component of the socket element. In this case the sealing element of the socket element would tightly seal the orifice in the uncoupled state and the seal of the plug element would tightly seal the orifice in the coupled state. In addition or alternatively, a seat could also be mounted on or applied to a sealing element.

The socket housing may be composed of at least two housing parts. If the parts are detachably fastened, opening of the housing and replacement of damaged components are possible. The housing parts are, for example, an upper and lower housing part or a right and left housing part. Assembly can be affected by plugging together. Alternative connections, in particular by means of detachable interlocking, such as locking or snap connections to the customary corresponding connection partners are equally possible. A further alternative is locking—for example external locking. The socket house can, however, equally be in the form of a single piece.

At least two electrically conductive socket contact elements are used in the socket housing. A socket/plug coupling unit having in each case two socket and plug contact elements could, for example, be in the form of a jack plug. In general, a plurality of contact elements for example ten contact elements, are used. The socket contact elements have in each case a region for a contact with conductor elements or connection to conductor elements, such as a circuit board or wires, and in each case a region for the contact with the plug contact elements. If the region for the contact with the plug contact elements is in the form of an arched contact point—for example an arched surface produced by a soldered-on layer or by a punching/bending process—contact can still be produced even in the case of slightly rotated or displaced socket and/or plug contact elements.

The connection region of the socket contact elements is in general outside the socket housing so that a simple connection, for example by soldering, is possible. After this region has been installed, usually in a device or a cable housing, it is not exposed to external influences. That side of the socket contact elements which has the plug contact region is completely within the socket housing—this side of the socket contact elements is therefore likewise completely shielded from the outside. The socket contact elements are tightly enclosed in the socket housing by the orifice tightly closed in cooperation with the abovementioned seating element in the case of the uncoupled socket element and plug element, and by the orifice tightly closed in cooperation with the at least partly introduced plug element in the case of coupled socket element and plug element.

The socket contact elements are advantageously elastic. Because the socket contact elements are elastic, for example springy, they can yield during displacement of the sealing element—they are, for example, bent outwards and spring back into the starting position after the sealing element has been pushed further past, so that they make contact with sufficient pressure with the plug contact elements of the plug element introduced through the orifice. For this purpose, the seating element is mounted, for example, in the middle between the socket contact elements and extended in the lower region to such an extent that, in the uncoupled state, there is an all round connection with the orifice, and said sealing element is tapered toward its middle. In the uncoupled state, the “retaxed” socket contact elements rest against the tapered region of the sealing element. On introduction of the plug element, the sealing element is now pushed in the coupling direction. Because the sealing element is extended at the bottom, the socket contact elements are bent outward on displacement of said sealing element and spring back into the “relaxed” position after the sealing element has been pushed past, after which they rest with the required contact pressure against the corresponding contact points or contact areas of the plug contact elements of the inserted plug element.

A centered arrangement of the sealing element in the socket housing is particularly advantageous when the socket contact elements are likewise arranged symmetrically relative to the middle of the socket—for example to the left or right of the central transverse axis or perpendicular thereto or radially symmetrical relative to the middle of the socket. The sealing element can of course also be arranged in a non-centered manner, for example in the case of a one-sided arrangement of the socket contact elements.

The arrangement and displacement of the sealing element can also be supported by guide elements, for example guides on the sealing element and corresponding rails on the socket housing, or vice versa.

The counterpart to the socket element is the plug element. The plug element comprises a plug housing having plug contact elements. On the plug socket side (cf. for example FIG. 1), the dimension of that part of the plug element to be inserted corresponds to the orifice of the socket housing through which the plug element is introduced during coupling. The part to be inserted may be the plug housing or a part of the plug housing. If appropriate the plug contact elements, for example in the form of a jack, can also form the part to be inserted.

The plug contact elements can be injection molded or integrally cast in the housing. For example the plug contact elements are injection molded with the material forming the plug housing, such as plastic, around them so that they are planar with lateral surfaces of the plug housing. The housing can also be formed only as a retaining part for the plug contact elements, for example as a flange in which the contacts are held.

The plug contact elements are arranged corresponding to the arrangement of the socket contact elements. In the case of correspondingly formed socket contact elements—for example more strongly springy ones—the plug contact elements can also be arranged deeper in the plug housing. It would also be possible to provide an outer protective covering around the plug contact elements, which is displaced (pushed downward) during coupling and is pushed back over the plug contact elements during uncoupling, for example automatically via a spring mechanism. On the plug connection side, the plug element can be connected via the plug contact elements in a customary manner to corresponding electrically conductive elements, such as wires, etc.

Plug element and/or socket element can furthermore be gas-tight, for example by sealing cavities of the plug housing and/or socket housing with an appropriate potting compound. The gas-tight formation can be provided in particular with regard to installation of plug element or socket element in a gas-tight sighting device. Usually, the plug element is installed in the sighting device.

In the embodiment of a socket/plug coupling unit according to the invention which is shown below, the socket element and plug element are not self-locking. An inner or outer locking mechanism can be coordinated with the socket element and plug element. If appropriate, the locking can also be provided on the device in which the installation is effected. Plug element and/or socket element can also be installed in handle-like outer housings provided for manual handling and having cables, it being possible to effect the mechanical locking by appropriate formation of the outer housings, for example by means of catches or bayonet connections.

Below, the invention is described in more detail purely by way of example with reference to a working example shown in the drawings. Specifically,

FIG. 1 shows a diagram of socket element and plug element in the uncoupled state in an isometric view,

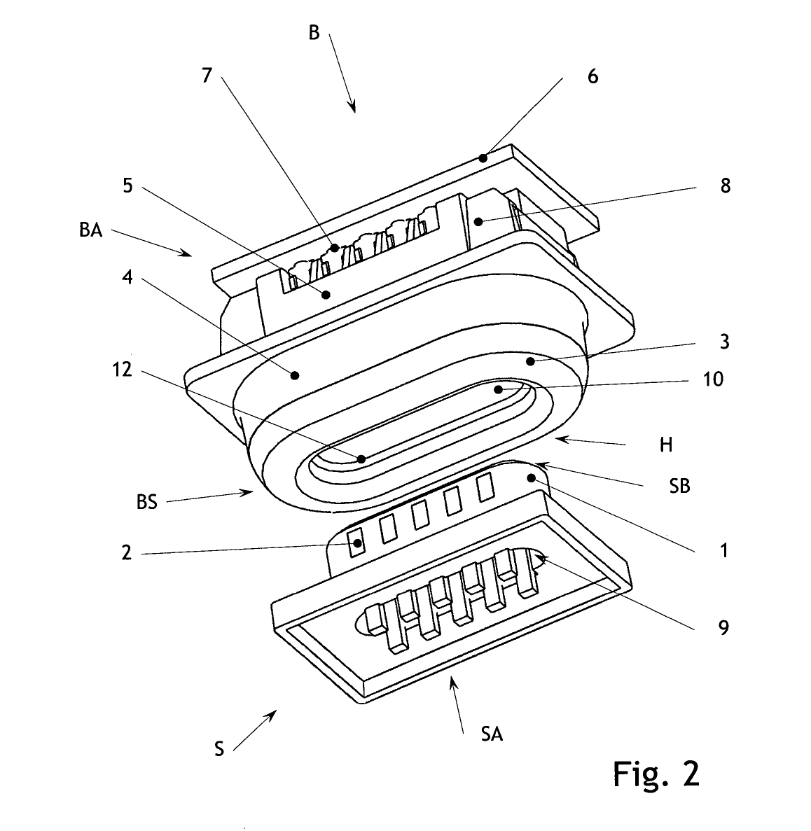

FIG. 2 shows a diagram of a socket element and plug element in the coupled state in an isometric view,

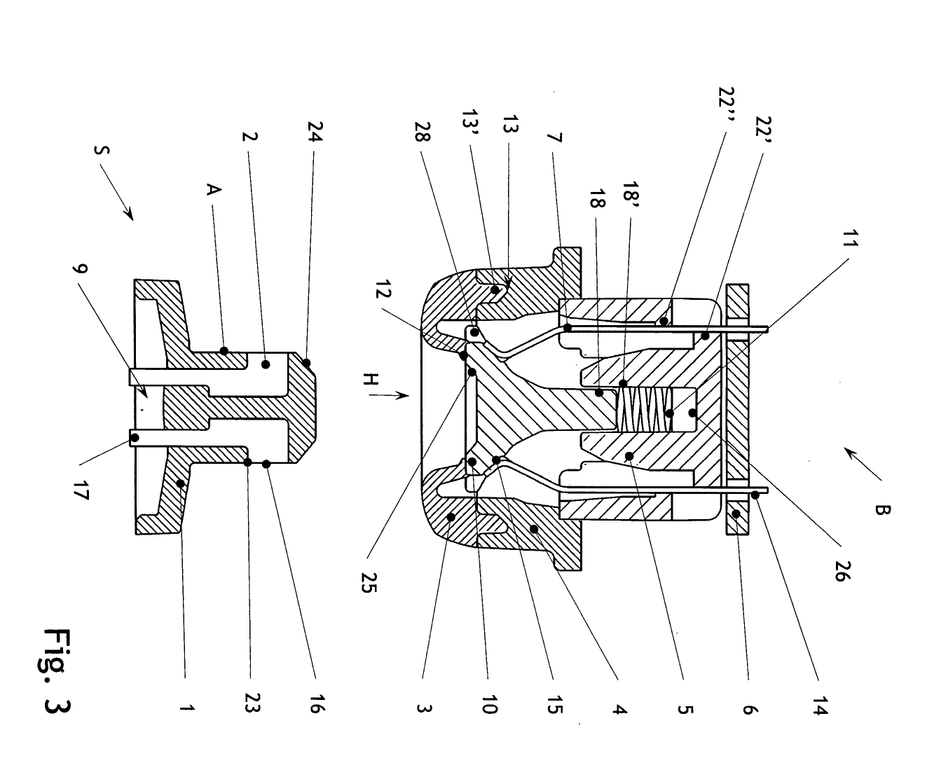

FIG. 3 shows a sectional view of a socket element and plug element in the uncoupled state along the central longitudinal axis thereof,

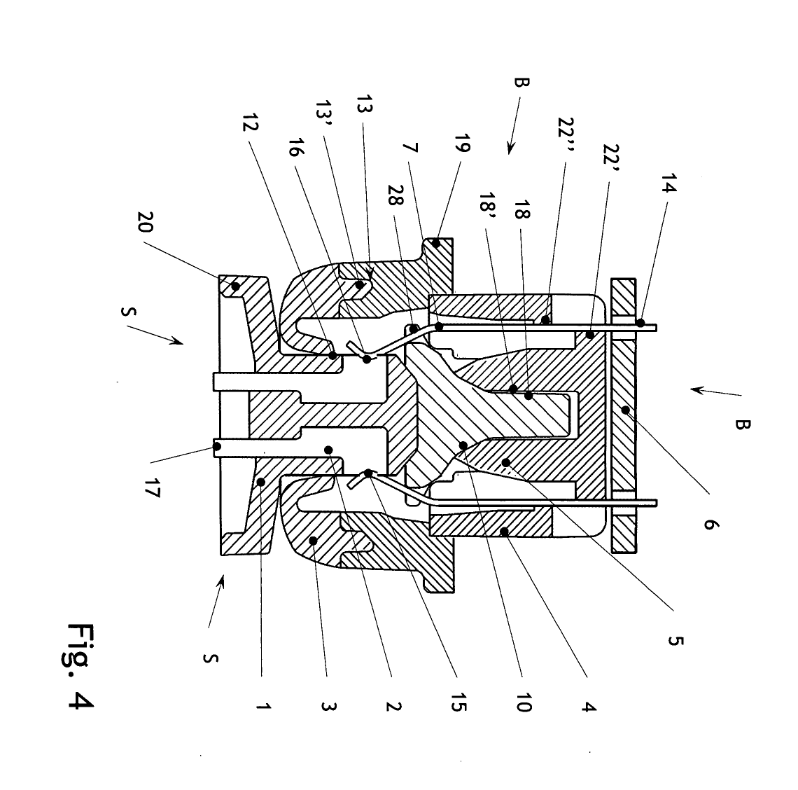

FIG. 4 shows a sectional view of socket element and plug element in the coupled state along the central longitudinal axis thereof,

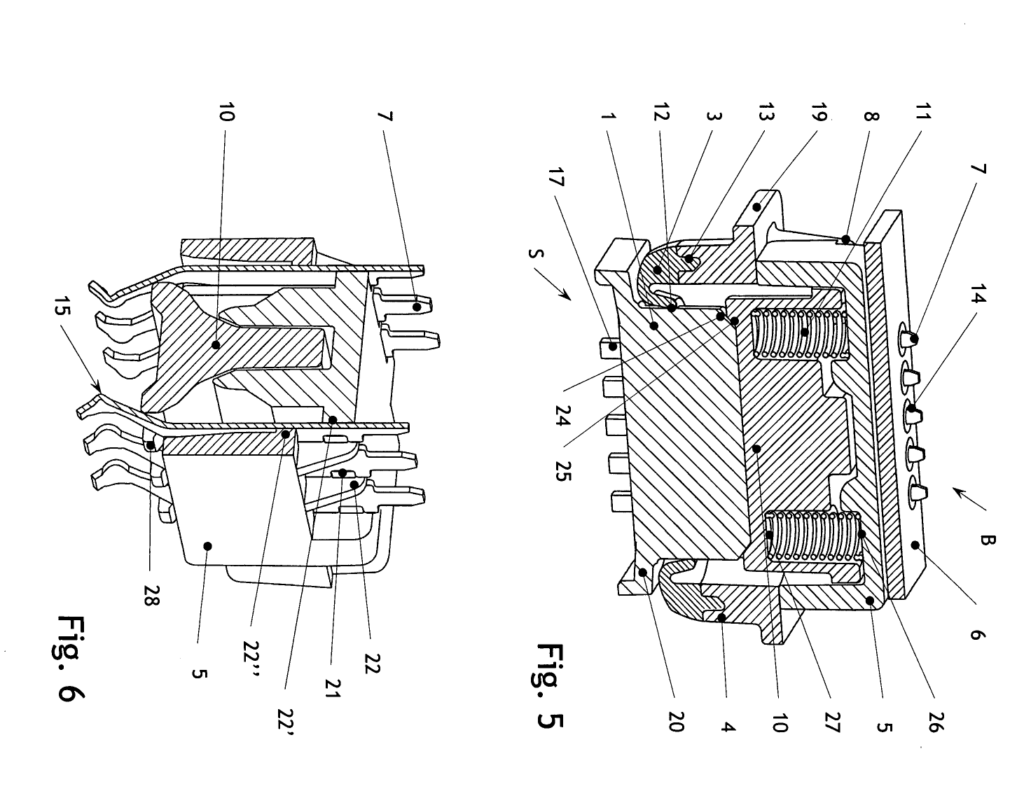

FIG. 5 shows a sectional diagram of the socket element and plug element in the coupled state and along the central transverse axis thereof in isometric view,

FIGS. 6 shows an isometric sectional view of components of the socket element.

FIGS. 1 and 2 show a socket element B and a plug element S of a socket/plug coupling unit in the uncoupled state. The isometric views show the elements in partial front and side view and in partial plan view in FIG. 1 and partial view from the bottom in FIG. 2. That side of the socket element B on which the coupling with the plug element S takes place is referred to as socket plug side BS. Accordingly, that side of the plug element B on which the coupling with the plug element S takes place is referred to as plug socket side SB. That side of the socket or plug element B or S, respectively, on which the connection to further conductor elements takes place is referred to as socket connection side BA and plug connection side SA, respectively.

The socket housing of the socket element B of the embodiment shown is composed of a first, lower housing part 4 on the socket plug side and a second, upper housing part on the socket connection side, which is referred to below as contact holder 5, via a plug connection. For this purpose, locking hooks 8 which snap into recesses 8′ of the contact holder 5 which are provided to this end are provided on the lower housing part. After having been plugged together, the parts interlock.

The socket contacts 7 arranged in the socket housing are used in the contact holder 5 and in each case form a linear arrangement to the right and left of and symmetrically with the central transverse axis QA of the socket element B. To illustrate a possible connection of the socket element B, a holding plate 6 into which the socket contact elements 7 are soldered at soldering points 14 on the socket connection side BA is shown in the working example illustrated. The holding plate 6 is, for example, an independent circuit board or a part of a circuit board of a device. On the side intended for contact with the plug contact elements 2, the socket contact elements 7 are completely in the socket housing.

The socket housing has at the bottom—on the socket plug side—an orifice H through which the plug element S can be inserted with its plug socket side SB. Insertion of the plug element S establishes the coupled state in which socket contact elements 7 and plug contact elements 2 touch. Along the edge region of the orifice H, a sealing ring 3 is arranged all round as a sealing component. The sealing ring 3 is adapted to the geometry of the orifice H and has an oval shape here. The arrangement and formation of the sealing ring 3 is shown in more detail in FIGS. 3 to 5. In the uncoupled state shown, a sealing element mounted in the socket housing and in the form of a sealing plug 10 rests against a sealing lip of the seating ring 3, which seating lip runs all round on the inside. As a result, the electrical socket contact elements 7 in the housing interior are completely protected from the outside.

The plug element S has plug contact elements 2 which correspond to the socket contact elements 7 and are surrounded by the molding material, e.g. plastic, which forms the plug housing 1. The plug contact elements 2 are used in the plug housing 1 in such a way that their contact surfaces intended for contact with the socket contact elements 7 lie in a plane with the outer surface of the plug housing 1. On the plug connection side SA the plug element S can be connected, e.g. soldered, to a circuit board or wires or flat conductor via the plug contact elements 2. Here, the plug element S is made gas-tight by sealing the hollow region between the plug contact elements 2 and the plug housing 1 with a potting compound.

FIGS. 3 and 4 show a section through the socket/plug coupling unit along the central longitudinal axis LA (cf. FIG. 1), the socket/plug coupling unit being shown in the uncoupled state in FIG. 3 and in the coupled state in FIG. 4. From the sectional diagrams of the uncoupled and coupled states, in particular the functions of the respective components or the formation of the respective components is comprehensible.

Thus, for example, the form of the socket contact elements 7 inserted into the contact holder 5 is clearly evident. The socket contacts 7 are spring-loaded and slightly angled in their lower region on the socket plug side so that, in the uncoupled state of FIG. 3, they rest against the sealing plug 10. The region of the socket contacts 7 which rests against the sealing plug 10 forms the contact region for the plug contacts 2. In the embodiment shown, the contact region is provided with a soldered-on layer which forms an arched contact area 15.

On insertion of the plug element S through the orifice H into the socket element B the sealing plug 10 is pushed into the socket housing by means of the plug element S. Owing to the shape of the sealing plug 10, the socket contacts 7 are spread or bent outward during the movement of the sealing plug 10. Once the sealing plug 10 has been pushed beyond the contact areas 15 the socket contacts 7 spring back to their previous position so that—as shown in FIG. 4—they rest with their contact areas 15 against the planar contact surfaces 16 of the plug contact elements 2 in the coupled socket element B and plug element S. In the position corresponding to FIG. 4, the socket contact elements 7 and plug contact elements 2 rest against one another with appropriate contact pressure so that an electrical connection forms.

For producing the coupled state, the plug element S is pushed through the orifice H of the socket housing. As an insertion aid, the plug element S and the sealing plug 10 are profiled with corresponding contours—the plug element S has a bevel-like plug contour 24 and the sealing plug 10 has a likewise bevel-like contour 25. As a result, the plug element S is positioned centrally on the sealing plug 10 and the latter is pushed axially (in the direction of a longitudinal axis) into the socket housing when the plug element S is pushed in the coupling direction—i.e. in the direction of the plug connection side SA.

The oval sealing ring 3 is arranged all round along the edge region of the orifice H. The socket housing has, around the orifice H, an all round groove 13 into which the sealing ring 3 having a corresponding profile 13′ is inserted. Sealing ring 3 and socket housing have a material connection. The seal 3 furthermore has a sealing lip 12 which runs all round its inner circumference and, in cooperation with the sealing element 10 in the socket housing (FIG. 3) or with the plug housing 1 (FIG. 4), forms a water-tight seal for the orifice H. Moreover, on insertion of the plug element S into the socket housing, any dirt or moisture is scraped off the plug housing 1 or off the plug contact elements 2 by the sealing tip 12.

In the uncoupled state of FIG. 3, the orifice H is sealed water-tight by means of sealing Lip 12 and sealing plug 10. The sealing plug 10 is spring-mounted in the contact holder 5. The sealing plug 10 is prestressed against the sealing lip 12 by the force of the spring 11, the sealing plug 10 and sealing lip 12 being designed in such a way that an all round connection is present. Consequently, the socket contacts 7 are completely protected from the outside even in the uncoupled state, so that the tightness of the current-carrying element is ensured in all operating modes of the socket/plug coupling unit. In order to apply the required spring force, mounting by means of two springs 11—as in the embodiment shown (cf. for example FIG. 5)—is expedient. When the plug element S is inserted, the sealing plug 10 is pushed against the force of the spring 11 into the interior of the socket until the socket contacts 7 and the plug contact elements 2 touch via their contact points 15 and contact surfaces 16, and the electrical connection is produced.

The displacement and arrangement of the sealing plug 10 in the socket housing is supported by guide elements—for example, as shown, by rails 18′ on the contact holder 5 and guides 18 on the sealing plug 10.

The socket contact elements 7 are inserted into slot-like orifices of the socket contact holder 5. The slot partitions 22 of the contact holder 5 prevent lateral displacement of the socket contact elements 7. The slot partitions 22 are clearly visible in FIG. 6. Furthermore, the socket contact elements rest against contact support surfaces 22′, 22″ of the contact holder 5. On the socket connection side, the socket contact elements 7 are soldered to the retaining plate 6 at the solder points 14. Of course, this representation is purely by way of example and the socket contacts 7 can be connected to alternative customary electrical conductive elements.

The section through the plug element S shows the plug contacts 2 which are injection molded in the plug housing 1 and are surrounded by molding material in such a way that interlocking is ensured in all directions. The contact surfaces 16 of the plug contacts 2 are planar with the corresponding outer surfaces A of the plug housing 1. The outer surfaces A of the plug housing 1 are as smooth as possible and free of steps, grooves or burrs, for example by mechanical processing, such as by milling, planing or grinding, of the surface transition 23 between plug housing 1 and plug contacts 2, with the result that, inter alia, durability and good scraping function on the sealing lip 12 are promoted. At those ends 17 of the plug contact elements 2 which are substantially opposite the contact surfaces 16, customary conductor elements can be connected in a customary manner. The plug element S is formed to be gas-tight by means of the potting compound 9.

FIG. 5 shows a section through the socket/plug coupling unit along the central transverse axis QA thereof (cf. FIG. 1), the socket/plug coupling unit being showed in the coupled state—analogously to FIG. 4.

The mounting of the sealing plug 10 in the socket housing or in the contact holder 5 is clearly evident. By means of two springs 11—shown here as coil springs—the sealing plug 10 is displaceably mounted in the contact holder 5 and is subjected to spring force. Contact holder 5 and sealing plug 10 have receptacles for the springs, the contact holder 5 in the form of support surfaces 26 and the sealing plug 10 in the form of blind holes 27.

In the coupled state shown, the sealing plug 10 is pushed or pressed into the socket housing against the spring force approximately by the extension of the inserted plug element S. Since the socket/plug coupling unit is not self-locking, it is necessary to use corresponding external mechanical locking in order to keep the unit in the coupled state. It is of course also possible to form the socket/plug coupling unit according to the invention with a self-locking mechanism.

If socket element B and/or plug element S are installed in a device, locking components—e.g. of the device—which are adapted to the functions and the design of the devices can be used for locking socket element and plug element B,S. In the working example shown, the socket element B has a flange 19 on the socket housing and the plug element S has a flange 20 on the plug housing 1, which flange 19 or 20 can, for example, be adhesively bonded or cast in electronic devices. The respective flange 19 or 20 for installation of the socket element B and plug element S can be advantageous for a large number of applications. Thus, the plug element S and/or the socket element B are installed, for example, in handle-like outer housings intended for manual handling and having cables, mechanical locking being effected by appropriate formation of the outer housing, such as by means of catches or bayonet connections.

FIG. 6 shows a sectional diagram along the central longitudinal axis (LA) in isometric view of the contact holder 5 with the socket contact elements 7 and the sealing plug 10 of the socket element. In this view, the slots and the slot partitions 22 for the socket contact elements 7 of the contact holder 5 are clearly visible. The slot partitions 22 furthermore have contact fixing cams 21 in order reliably to prevent displacement of the socket contacts 7 between the slot partitions 22. Thus, the correct position of the socket contact elements 7 is ensured during assembly before the further connection of the socket contact elements 7 to the socket connection side—for example, introduction of mechanical loads into the solder points 14 is prevented in this manner. The socket contact elements 7 are furthermore secured by the sealing plug 10 to prevent lateral displacement, by virtue of the fact that said sealing plug has tooth-like retaining elements 28 between which the socket contacts 7 are arranged.

1. A socket/plug coupling unit comprising
a socket element (B) having a socket housing comprising electrically conductive socket contact elements (7) and
a plug element (S) which can be detachably coupled to the socket element (B) and has a plug housing (1) comprising electrically conductive plug contact elements (2),
the socket element (B) being capable of being electrically connected via the socket contact elements (7)
to a socket connection side (BA) having first conductor elements and
to a socket plug side (BS) having the plug contact elements (2), and the plug element (S) being capable of being electrically connected via the plug contact elements (2)
to a plug connection side (SA) having second conductor elements and
to a plug socket side (SB) having the socket contact elements (7),
the socket contact elements (7) being present completely within the socket housing on the socket plug side, and
the plug being capable of being inserted through an orifice (H) of the socket housing at least partially into the socket housing for coupling of socket and plug element (B,S) and hence production of the electrical connection of the socket and plug contact elements (7, 2) and
the plug element (S) being removable from the socket housing for uncoupling socket and plug element (B, S), wherein
the socket element (B) has a sealing element, such as a sealing plug (10), which is displaceably mounted in the socket housing so that it
is pressed indirectly or directly against the edge of the orifice (H) when socket and plug element (B, S) are uncoupled, so that the orifice (H) is tightly sealed, and
is moved substantially by the extension of the inserted plug element (S) in the direction of the socket connection side (B) into the socket housing when socket and plug element (B,S) are coupled,
and wherein, when socket and plug element (B, S) are coupled, the plug housing (1) rests indirectly or directly against the edge of the orifice (H) so that the orifice (H) is tightly sealed.

2. The socket/plug coupling unit as claimed in claim 1, wherein an all round sealing component, such as a sealing ring (3), having a sealing lip (12) running all around along the inner circumference of the sealing component is arranged along the edge region of the orifice (H), and the seating element is pressed against the sealing lip (12) in the uncoupled state.

3. The socket/plug coupling unit as claimed in claim 2, wherein an all round groove (13) for receiving a corresponding profile (13′) provided on the sealing component is formed in the socket housing along the edge region of the orifice (H).

4. The socket/plug coupling unit as claimed in any of claims 1 to 3, wherein the sealing element
is displaceably mounted in the socket housing and subjected to force by means of at least one spring (11), in particular by means of at least two springs (11), and
is pressed by spring force indirectly or directly against the edge of the orifice (H) when socket and plug element (B, S) are uncoupled and
is moved into the socket housing against the spring force when socket and plug element (B, S) are coupled.

5. The socket/plug coupling unit as claimed in claim 4, wherein the sealing element has at least one receptacle, for example, in the form of a blind hole (27), for the at least one spring (11).

6. The socket/plug coupling unit as claimed in any of the preceding claims, wherein
the plug element (S) has a plug contour (24) for example a bevel-like one, on the plug socket side and
the sealing element has a contour (25), for example a bevel-like one, diametrically opposed to the plug contour (24) as a centering and insertion aid for the plug element (S).

7. The socket/plug coupling unit as claimed in any of preceding claims, wherein the sealing element is centered in the socket element (B) and is axially displaceable in the direction of the longitudinal axis of the socket element (B) for which purpose guide elements such as guides (18) and rails (18′), are provided on the sealing element and on the socket housing.

8. The socket/plug coupling unit as claimed in any of the preceding claims wherein the sealing element has tooth-like retaining elements (28) for the socket contact elements (7), in particular springy socket contact elements (7), so that the socket contact elements (7) are arranged in the socket housing between the retaining elements (28) and are thus secured to prevent lateral displacement.

9. The socket/plug coupling unit as claimed in any of the preceding claims wherein the socket housing can be composed or is composed of a first housing part (4) and a second housing part (5), the first housing part (4) having locking hooks (8) for snapping into corresponding recesses of the second housing part (5).

10. The socket/plug coupling unit as claimed in any of the preceding claims, wherein the plug element (S) is formed in such a way that the plug contact elements (2) lie in a plane with the outer surface (A) of the plug housing (1) on the plug socket side (SB).

11. A socket element (B) for a socket/plug coupling unit as claimed in any of the preceding claims.

12. A plug element (S) for a socket/plug coupling unit as claimed in any of claims 1 to 10.
